(19) United States
(12) Patent Application Publication
(10) Pub. No.: US 2024/0074479 A1
(43) Pub. Date: Mar. 7, 2024

(54) FIBER BLENDS, SWEETENED FIBER BLENDS, AND THEIR COMESTIBLE USE

(71) Applicant: Firmenich SA, Satigny (CH)

(72) Inventors: Maria MARTINEZ-VILLAGRAN, Plainsboro, NJ (US); Wendy IWANYSHYN, Plainsboro, NJ (US)

(73) Assignee: Firmenich SA, Satigny (CH)

(21) Appl. No.: 18/262,314

(22) PCT Filed: Feb. 7, 2022
(86) PCT No.: PCT/EP2022/052878

§ 371 Date: Jul. 20, 2023

Related U.S. Application Data
(60) Provisional application No. 63/147,942, filed on Feb. 10, 2021.
(60) Provisional application No. 63/149,655, filed on Feb. 15, 2021.

(30) Foreign Application Priority Data
Feb. 24, 2021 (EP) 21159030.2

(51) Int. Cl. A23L 33/21; A23C 9/154; A23C 9/156; A23C 11/10; A23L 11/60

(52) U.S. Cl. CPC A23L 33/21; A23C 9/1544; A23C 9/156; A23C 11/10; A23L 11/60

(57) ABSTRACT

The present disclosure relates generally to fiber blends and their use in various comestible products, such as food products, beverage products, nutritional products, dairy analogues, meat analogies, and animal feed products. In some embodiments, the fiber blends contain prebiotic fibers, such as inulin, for example to deliver health and nutrition benefits, as well as, additional benefits, such as texture, binding, bulking, viscosity enhancement, and the like. In some embodiments, the fiber blends contain psyllium fiber. In some embodiments, the fiber blends contain a combination of texturizing fibers, such as pea fiber, potato fiber, and the like. In some embodiments, the fiber blends contain digestion-resistant dextrin. In some embodiments, the fiber compositions also contain one or more sweeteners, such as sugars, high-intensity sweeteners, or a combination thereof, for example, in dry form or as a symp. In some aspects, the disclosure provides the use of such fiber blends in various comestible products, such as food products, beverage products, food supplements, or animal feed products. In some embodiments, such comestible products are meat analogue products or dairy analogue products. In some embodiments, the fiber blends contain combinations of soluble and insoluble fibers in certain relative amounts for health and nutrition benefits.

### CROSS-REFERENCE TO RELATED APPLICATIONS

The present application claims the benefit of priority to United States Provisional Application Nos. 63/147,942, filed Feb. 10, 2021, and 63/149,655, filed Feb. 15, 2021, and European Patent Application No. 21159030.2, filed Feb. 24, 2021, all of which are hereby incorporated by reference as though set forth herein in their entireties.

### TECHNICAL FIELD

The present disclosure relates generally to fiber blends and their use in various comestible products, such as food products, beverage products, nutritional products, dairy analogues, meat analogies, and animal feed products. In some embodiments, the fiber blends contain prebiotic fibers, such as inulin, for example to deliver health and nutrition benefits, as well as, additional benefits, such as texture, binding, bulking, viscosity enhancement, and the like. In some embodiments, the fiber blends contain psyllium fiber. In some embodiments, the fiber blends contain a combination of texturizing fibers, such as pea fiber, potato fiber, and the like. In some embodiments, the fiber blends contain digestion-resistant dextrin. In some embodiments, the fiber compositions also contain one or more sweeteners, such as sugars, high-intensity sweeteners, or a combination thereof, for example, in dry form or as a syrup. In some aspects, the disclosure provides the use of such fiber blends in various comestible products, such as food products, beverage products, food supplements, or animal feed products. In some embodiments, such comestible products are meat analogue products or dairy analogue products. In some embodiments, the fiber blends contain combinations of soluble and insoluble fibers in certain relative amounts for health and nutrition benefits.

### DESCRIPTION OF RELATED ART

The diet of most people in developed parts of the world has increasingly moved towards food and beverages made from processed or refined ingredients. This processing often removes much of the soluble and insoluble fiber present naturally in unprocessed or minimally processed foods. As a result, people increasingly consume diets that have much lower amounts of soluble and insoluble fiber than what is ideal.

Adding fiber into such processed foods is a common way to increase fiber content in foods and beverages. For example, energy bars and health drinks may include soluble and insoluble fibers to address the fiber deficit that is typically present in such foods. But the inclusion of fiber often imparts an unpleasant taste, such as a bitter taste, or an unpleasant mouthfeel. Further, such fibers may not include beneficial balances of soluble and insoluble fibers, which may detract from some of the gut-health benefits of consuming higher amounts of fiber, or may result in constipation or digestion issues.

Thus, there is a continuing need to develop fiber blends that impart the health benefits of consuming fiber without taking too much away from the desirable taste and mouthfeel of various food and beverage items.

### SUMMARY

The present disclosure relates to the discovery that certain fiber blends offer a beneficial taste profile or texture, and that are suitable for development as part of an integrated taste solution for direct use in food or beverage products.

In a first aspect, the disclosure provides a comestible composition comprising a fiber blend, wherein the fiber blend comprises (a) inulin, digestion-resistant dextrin, or a combination thereof, and, optionally, (b) a texturizing fiber component, which comprises plant-based soluble fiber and plant-based insoluble fiber. In some embodiments, the comestible composition further comprises a sweetener. In some such embodiments, the sweetener comprises one or more high-intensity sweeteners. In some embodiments, the comestible composition comprises a flavor.

In a second aspect, the disclosure provides uses of any comestible compositions of the first aspect.

In a third aspect, the disclosure provides uses of any comestible compositions of the first aspect to increase the fiber content (for example, the prebiotic fiber content) of a flavored product. In some embodiments, the comestible compositions of the first aspect deliver nutritional content benefits (such as improving the fiber content, so as to make the flavored product a “good source” of fiber or a “high source” of fiber on the package labeling) as well as, providing certain health benefits, such as supporting digestive wellness, regularity, blood sugar maintenance, prebiotic function, and the like, of a flavored product. In some embodiments, the flavored product is a food product, a beverage product, an oral care product, or an animal feed product (such as a dog feed or cat feed product).

In a fourth aspect, the disclosure provides uses of any comestible compositions of the first aspect to enhance the texture of a flavored product. In some embodiments, the flavored product is a food product, a beverage product, an oral care product, or an animal feed product (such as a dog feed or cat feed product). In some embodiments thereof, the comestible compositions of the first aspect enhance the texture of a liquid flavored product such as improving the texturizing property in liquids (such as milk, juices, etc.), such as creaminess, thickness, and the like. In some embodiments, the comestible compositions of the first aspect enhance the texture of solid flavored products (such as snack bars, cookies, cereals, extruded product, and the like). In some such cases, the enhanced attributes include crispiness, crunchiness, cohesiveness, and the like.

In a fifth aspect, the disclosure provides uses of any comestible compositions of the first aspect to enhance the mouthfeel of a flavored product. In some embodiments, the flavored product is a food product, a beverage product, an oral care product, or an animal feed product (such as a dog feed or cat feed product).

In a sixth aspect, the disclosure provides methods of increasing the fiber content (for example, the prebiotic fiber content) of a flavored product, the method comprising introducing an amount of any comestible compositions of the first aspect to the flavored product. In some such embodiments, introducing the comestible composition of the first aspect supports making certain nutritional claim on product packaging, such as labeling the product as such as a “good source” of fiber, or support making certain health-related claims. In some embodiments, the flavored product is a food product, a beverage product, an oral care product, or an animal feed product (such as a dog feed or cat feed product).

In a seventh aspect, the disclosure provides methods of enhancing the texture of a flavored product, the method comprising introducing an amount of any comestible compositions of the first aspect to the flavored product. In some embodiments, the flavored product is a food product, a beverage product, an oral care product, or an animal feed product (such as a dog feed or cat feed product).

In a seventh aspect, the disclosure provides methods of enhancing the mouthfeel of a flavored product, the method comprising introducing an amount of any comestible compositions of the first aspect to the flavored product. In some embodiments, the flavored product is a food product, a beverage product, an oral care product, or an animal feed product (such as a dog feed or cat feed product).

In an eighth aspect, the disclosure provides flavored products comprising any comestible compositions of the first aspect. In some embodiment, the flavored products are beverage products, such as soda, flavored water, tea, and the like. In some other embodiments, the flavored products are food products, such as yogurt. In some embodiments, the flavored products are animal feed product, such as cat feed or dog feed products.

Further aspects, and embodiments thereof, are set forth below in the Detailed Description, the Abstract, and the Claims.

### DETAILED DESCRIPTION

The following Detailed Description sets forth various aspects and embodiments provided herein. The description is to be read from the perspective of the person of ordinary skill in the relevant art. Therefore, information that is well known to such ordinarily skilled artisans is not necessarily included.

### Definitions

The following terms and phrases have the meanings indicated below, unless otherwise provided herein. This disclosure may employ other terms and phrases not expressly defined herein. Such other terms and phrases have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary

As used herein, “sweetener,” “sweet flavoring agent,” “sweet flavor entity,” or “sweet compound” all refer to a compound or a comestibly acceptable salt thereof that elicits a detectable sweet flavor in a subject, such as a compound that activates a human T1R2 or T1R3 receptor in the course of in vitro screening or that is reported to be sweet via sensory testing by human subjects.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “optionally” means that the subsequently described event(s) may or may not occur. In some embodiments, the optional event does not occur. In some other embodiments, the optional event does occur one or more times.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members, e.g., A₁ and A₂, then one or more members of the class can be present concurrently.

Other terms are defined in other portions of this description, even though not included in this subsection.

### Comestible Compositions

As noted above, in at least one aspect, the disclosure provides comestible compositions that comprise a fiber blend, wherein the fiber blend comprises (a) inulin, digestion-resistant dextrin, or a combination thereof, and, optionally, (b) a texturizing fiber component, which comprises plant-based soluble fiber and plant-based insoluble fiber. In some embodiments, the comestible composition further comprises a sweetener.

The component (a) of the fiber blend includes inulin, digestion-resistant dextrin, or a combination thereof.

As used herein, “inulin” refers to a class of polysaccharides having a sucrose base unit, wherein the 2-position of the fructose molecule of the sucrose is substituted with a polyfructose chain in which each fructose unit is connected to the next via beta-2,1 linkages. The polyfructose substituent typically includes from 2 to about 60 fructose units. In some embodiments, the lower-molecular-weight compounds may be removed during processing, leaving an inulin where the polyfructose substituent typically has from about 10 to about 60 fructose units. Inulin is most commonly found in chicory root, but can be found in over 35,000 different plant species, including wheat, onion, banana, garlic, agave, and Jerusalem artichoke.

As used herein, the term “digestion-resistant dextrin” or “resistant dextrin” refers to a derivative of dextrin in which the glucose units in the dextrin are enzymatically modified to be indigestible in humans. It is typically derived from corn, and can also be referred to as “soluble corn fiber.” As a shorthand, digestion-resistant dextrin may be referred to herein as “DRD.” As used herein, the term “dextrin” encompasses polysaccharides having D-glucose units connected by alpha-1,4 linkages, alpha-1,6 linkages, or a combination thereof. Thus, the term “dextrin” encompasses maltodextrin, which is a polysaccharide having D-glucose units connected by alpha-1,4 linkages. In some embodiments of any of the embodiments set forth herein, the digestion-resistant dextrin is digestion-resistant maltodextrin. Other resistant dextrins include wheat or pea starch.

In some embodiments, the component (a) comprises inulin. The inulin can be present in any suitable amount relative to the total fiber content in the comestible composition. For example, in some embodiments, the concentration of inulin in the comestible composition ranges from 75 percent by weight to 97 percent by weight, or from 80 percent by weight to 95 percent by weight, based on the total weight of fiber in the comestible composition. In some other embodiments in which inulin is present, the concentration of inulin in the comestible composition ranges from 50 percent by weight to 75 percent by weight, or from 55 percent by weight to 75 percent by weight, based on the total weight of fiber in the comestible composition. In some other embodiments in which inulin is present, the concentration of inulin in the comestible composition ranges from 40 percent by weight to 60 percent by weight, or from 45 percent by weight to 55 percent by weight, based on the total weight of fiber in the comestible composition. In some other embodiments in which inulin is present, the concentration of inulin in the comestible composition ranges from 10 percent by weight to 20 percent by weight, or from 12 percent by weight to 18 percent by weight, based on the total weight of fiber in the comestible composition.

In some embodiments, the component (a) comprises DRD. The DRD can be present in any suitable amount relative to the total fiber content in the comestible composition. For example, in some embodiments, the concentration of DRD in the comestible composition ranges from 75 percent by weight to 95 percent by weight, or from 80 percent by weight to 95 percent by weight, based on the total weight of fiber in the comestible composition. In some other embodiments in which DRD is present, the concentration of DRD in the comestible composition ranges from 15 percent by weight to 30 percent by weight, or from 20 percent by weight to 25 percent by weight, based on the total weight of fiber in the comestible composition. In some other embodiments in which DRD is present, the concentration of DRD in the comestible composition ranges from 3 percent by weight to 20 percent by weight, or from 5 percent by weight to 15 percent by weight, based on the total weight of fiber in the comestible composition. In some other embodiments in which DRD is present, the concentration of DRD in the comestible composition ranges from 40 percent by weight to 60 percent by weight, or from 45 percent by weight to 55 percent by weight, based on the total weight of fiber in the comestible composition. In some other embodiments in which DRD is present, the concentration of DRD in the comestible composition ranges from 55 percent by weight to 75 percent by weight, or from 60 percent by weight to 70 percent by weight, based on the total weight of fiber in the comestible composition. In some other embodiments in which DRD is present, the concentration of DRD in the comestible composition ranges from 25 percent by weight to 45 percent by weight, or from 30 percent by weight to 40 percent by weight, based on the total weight of fiber in the comestible composition.

In some embodiments, component (a) of the comestible composition comprises both inulin and DRD, according to any combination of embodiments set forth above. For example, in some embodiments, the concentration of inulin in the comestible composition ranges from 75 percent by weight to 97 percent by weight, or from 80 percent by weight to 95 percent by weight, and the concentration of DRD in the comestible composition ranges from 5 percent by weight to 20 percent by weight, or from 5 percent by weight to 15 percent by weight, both based on the total weight of fiber in the comestible composition. In some other embodiments, the concentration of inulin in the comestible composition ranges from 50 percent by weight to 75 percent by weight, or from 55 percent by weight to 75 percent by weight, and the concentration of DRD in the comestible composition ranges from 15 percent by weight to 30 percent by weight, or from 20 percent by weight to 25 percent by weight, both based on the total weight of fiber in the comestible composition. The inulin and DRD can be present in the comestible composition in any suitable weight ratio relative to each other. For example, in some embodiments, the weight ratio of inulin to DRD ranges from 15:1 to 25:1, or from 16:1 to 22:1. In some other embodiments, the weight ratio of inulin to DRD ranges from 3:1 to 8:1, or from 4:1 to 7:1.

In some embodiments, component (a) can further comprise galact-oligosaccharides, fructo-oligosaccharides, acacia fiber, soluble pea fiber, soluble wheat fiber, arabinoxylan, isomalto-oligosaccharides, xylo-oligosaccharides, and the like.

In certain embodiments, the comestible compositions comprise a component (b), a texturizing fiber component, which comprises plant-based soluble fiber and plant-based insoluble fiber, for example, with the ability to develop apparent viscosity, high water absorption index, and small particle size distribution.

The texturizing fiber component, when present, can have any suitable concentration in the comestible composition relative to component (a). In some embodiments, the texturizing component is present in the comestible composition at a concentration of from 1 percent by weight to 8 percent by weight, or from 3 percent by weight to 7 percent by weight, based on the total weight of fiber in the comestible composition. In some other embodiments, the texturizing component is present in the comestible composition at a concentration of from 10 percent by weight to 20 percent by weight, or from 12 percent by weight to 18 percent by weight, based on the total weight of fiber in the comestible composition. In some other embodiments, the texturizing component is present in the comestible composition at a concentration of from 6 percent by weight to 14 percent by weight, or from 7 percent by weight to 13 percent by weight, based on the total weight of fiber in the comestible composition. In some other embodiments, the texturizing component is present in the comestible composition at a concentration of from 40 percent by weight to 60 percent by weight, or from 45 percent by weight to 55 percent by weight, based on the total weight of fiber in the comestible composition. In some other embodiments, the texturizing component is present in the comestible composition at a concentration of from 55 percent by weight to 75 percent by weight, or from 60 percent by weight to 70 percent by weight, based on the total weight of fiber in the comestible composition. In some other embodiments, the texturizing component is present in the comestible composition at a concentration of from 25 percent by weight to 45 percent by weight, or from 30 percent by weight to 40 percent by weight, based on the total weight of fiber in the comestible composition.

The texturizing component comprises both soluble and insoluble fiber. Component (b) can have any suitable weight ratio of soluble fiber to insoluble fiber. In some embodiments, the weight ratio of soluble fiber to insoluble fiber ranges from 1:3 to 3:1, or from 1:2 to 2:1, or from 2:3 to 3:2. In some embodiments, the ratio of soluble to insoluble fiber is designed to thicken a beverage product to have a viscosity ranging from 5 cP to 50 cP, when added so as to make a finished product.

The texturing fiber component is made up of plant-based fibers. The plant-based fibers can be sourced from any plant-based fibrous material suitable for consumption by humans or animals. Suitable examples include, but are not limited to, nut fibers, grain fibers, rice fibers, seed fibers, oat fibers, pea fibers, berry fibers, soybean fibers, banana fibers, citrus fibers, apple fibers, carrot fibers, pectin fibers, fenugreek fibers, and psyllium fibers.

In some embodiments, it may be desirable to adjust the pH of a flavored product (that incorporates the comestible composition) to have desirable stability and prebiotic function. In some embodiments that comprise inulin, the pH of the flavored product incorporating the comestible composition is 4.5 or greater. In some embodiments that comprise digestion resistant dextrin or galacto-oligosaccharides, the pH of the flavored product incorporating the comestible composition is 2.5 or greater.

In some embodiments, the texturizing fiber component (b) comprises pea fiber (which is mostly insoluble), psyllium fiber (which is partially soluble), and any combinations thereof. In some embodiments, the texturizing fiber component (b) comprises both pea fiber and psyllium fiber. In such embodiments, the pea fiber and the psyllium fiber can be present in any suitable concentration relative to each other. In some embodiments, the weight ratio of pea fiber to psyllium fiber present in the texturizing component (b) ranges from 1:1 to 3:1, or from 1:1 to 2:1.

In some further embodiments, the soluble fiber in the texturizing component (b) can be sourced from other known soluble fibers, such as pectin, cellulose ethers, carrageenan, guar gum, and the like. In some further embodiments, the insoluble fibers in the texturizing component (b) can be sourced from potato fiber, citrus fiber, and the like.

In some embodiments, the level of the texturizing component is adjusted, for example, the ratio of pea fiber and psyllium fiber, and the relative amount of fibers with prebiotic function (for example, inulin or digestion-resistant dextrin) was found to have a positive impact on the texture of the flavored products incorporating the comestible compositions, especially for ready-to-drink (RTD) beverages, protein-containing applications, and plant-based applications. For example, in some RTD beverages, when fortified or supplemented with natural fibers, the appearance and stability of the beverage is negatively affected due to the separation of the liquid on the top and the gel or hydrated particles at the bottom. In some embodiments, the weight ratio of pea fiber to psyllium fiber present in the comestible composition component (b) ranges from 1:1 to 3:1, or from 1:1 to 2:1. In some embodiments, the resulting flavored product is a solution.

Such preferences can be made in any suitable way. In some embodiments, the manufacturing method combines a high shear mixing of the dry ingredients with water followed by a homogenization step, which, with high pressure and temperature, the particle size of the natural fibers is decreased significantly, resulting in small particles that do not separate from the liquid and provide a smooth and creamy texture. This method provides the benefit of texturization of the RTD beverages. The natural fibers are first completely hydrated, to achieve swelling of the particles with a high shear mixing for a time from 15 minutes to 45 minutes, or from 20 minutes to 45 minutes. In some such embodiments, the use of such processes improves creaminess or smoothness of the resulting flavored product. The resulting viscosity values of the flavored product incorporating a comestible composition range from 15 cP to 60 cP, or from 20 cP to 60 Cp, or from 30 cP to 50 cP. In some cases, the particle size distribution (PSD) of the psyllium fiber can be important.

In some further embodiments, the comestible composition comprises a protein component (c), where the protein component comprises one or more proteins. In some embodiments, the protein component (c) comprises dairy proteins, such as whey protein, whey protein isolate, casein, and the like. In some embodiments, the protein component (c) comprises collagen. In some embodiments, the protein component (c) comprises egg protein. In some embodiments, the protein component (c) comprises non-animal-based proteins, such as pea protein, soy protein, almond protein, cashew protein, canola (rapeseed) protein, chickpea protein, mycoproteins, algal proteins, fava protein, sunflower protein, wheat protein, oat protein, potato protein, and the like.

In some applications, where high levels of protein (for example, plant-based protein), the texture of RTD beverages may be negatively affected due to the interaction between the proteins and fibers in the comestible composition. For example, in some cases, a large particle size distribution of plant based proteins may result in stability issues (separation of liquid and solids at the bottom), as well as grittiness.

In some embodiments, the comestible composition comprises (d) a sweetener. The sweetener can be present in any suitable concentration, depending on factors such as the sweetener's potency as a sweetener, its solubility, and the like. For example, in some embodiments, the sweetener is present in an amount from 0.1 weight percent to 12 weight percent. In some embodiments, the sweetener is present in an amount from 0.2% to 10% by weight. In some embodiments, the sweetener is present in an amount from 0.3% to 8% by weight. In some embodiments, the sweetener is present in an amount from 0.4% to 6% by weight. In some embodiments, the sweetener is present in an amount from 0.5% to 5% by weight. In some embodiments, the sweetener is present in an amount from 1% to 2% by weight. In some embodiments, the sweetener is present in an amount from 0.1% to 5% by weight. In some embodiments, the sweetener is present in an amount from 0.1% to 4% by weight. In some embodiments, the sweetener is present in an amount from 0.1% to 3% by weight. In some embodiments, the sweetener is present in an amount from 0.1% to 2% by weight. In some embodiments, the sweetener is present in an amount from 0.1% to 1% by weight. In some embodiments, the sweetener is present in an amount from 0.1% to 0.5% by weight. In some embodiments, the sweetener is present in an amount from 0.5% to 10% by weight. In some embodiments, the sweetener is present in an amount from 2% to 8% by weight. In some further embodiments of the embodiments set forth in this paragraph, the additional sweetener is sucrose, fructose (such as high-fructose corn syrup, fruit juice, and the like), glucose, xylitol, erythritol, glucose, allulose, or any combinations thereof.

In some other embodiments, the sweetener is present in an amount ranging from 10 ppm to 1000 ppm. In some embodiments, the sweetener is present in an amount from 20 ppm to 800 ppm. In some embodiments, the sweetener is present in an amount from 30 ppm to 600 ppm. In some embodiments, the sweetener is present in an amount from 40 ppm to 500 ppm. In some embodiments, the sweetener is present in an amount from 50 ppm to 400 ppm. In some embodiments, the sweetener is present in an amount from 50 ppm to 300 ppm. In some embodiments, the sweetener is present in an amount from 50 ppm to 200 ppm. In some embodiments, the sweetener is present in an amount from 50 ppm to 150 ppm. In some further embodiments of the embodiments set forth in this paragraph, the additional sweetener is a steviol glycoside (such as rebaudioside A, rebaudioside D, rebaudioside E, rebaudioside M, or any combination thereof), a mogroside (such as mogroside III, mogroside IV, mogroside V, siamenoside I, isomogroside V, mogroside IV_{E}, isomogroside IV, mogroside III_{E}, 11-oxomogroside V, the 1,6-α isomer of siamenoside I, and any combinations thereof), a derivative of either of the foregoing, such as glycoside derivatives (e.g., glucosylates), cyclamate, aspartame, sucralose, acesulfame K, or any combination thereof.

In general, the compositions can include any suitable sweeteners or combination of sweeteners. In some embodiments, the sweetener is a common saccharide sweeteners, such as sucrose, fructose, glucose, and sweetener compositions comprising natural sugars, such as corn syrup (including high fructose corn syrup) or other syrups or sweetener concentrates derived from natural fruit and vegetable sources. In some embodiments, the sweetener is sucrose, fructose, or a combination thereof. In some embodiments, the sweetener is sucrose. In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, isomalt, lactitol, mannitol, sorbitol, xylitol, maltodextrin, and the like. In some embodiments, the sweetener is selected from artificial sweeteners such as aspartame, saccharin, acesulfame-K, cyclamate, sucralose, and alitame. In some embodiments, the sweetener is selected from the group consisting of cyclamic acid, mogroside, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners. In some embodiments, the additional sweetener is a combination of two or more of the sweeteners set forth in this paragraph. In some embodiments, the sweetener may combinations of two, three, four or five sweeteners as disclosed herein. In some embodiments, the additional sweetener is a sugar. In some embodiments, the additional sweetener is a combination of one or more sugars and other natural and artificial sweeteners. In some embodiments, the additional sweetener is a sugar. In some embodiments, the sugar is cane sugar. In some embodiments, the sugar is beet sugar. In some embodiments, the sugar may be sucrose, fructose, glucose or combinations thereof. In some embodiments, the sugar is sucrose. In some embodiments, the sugar is a combination of fructose and glucose.

In some embodiments, the sweeteners can also include, for example, sweetener compositions comprising one or more natural or synthetic carbohydrate, such as corn syrup, high fructose corn syrup, high maltose corn syrup, glucose syrup, sucralose syrup, hydrogenated glucose syrup (HGS), hydrogenated starch hydrolyzate (HSH), or other syrups or sweetener concentrates derived from natural fruit and vegetable sources, or semi-synthetic “sugar alcohol” sweeteners such as polyols. Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like, and sugar alcohols or any other carbohydrates or combinations thereof capable of being reduced which do not adversely affect taste.

The sweetener may be a natural or synthetic sweetener that includes, but is not limited to, agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrhizin, glycyrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

In still other embodiments, the sweetener can be a chemically or enzymatically modified natural high potency sweetener. Modified natural high potency sweeteners include glycosylated natural high potency sweetener such as glucosyl-, galactosyl-, or fructosyl-derivatives containing 1-50 glycosidic residues. Glycosylated natural high potency sweeteners may be prepared by enzymatic transglycosylation reaction catalyzed by various enzymes possessing transglycosylating activity. In some embodiments, the modified sweetener can be substituted or unsubstituted.

Additional sweeteners also include combinations of any two or more of any of the aforementioned sweeteners. In some embodiments, the sweetener may comprise combinations of two, three, four or five sweeteners as disclosed herein. In some embodiments, the sweetener may be a sugar. In some embodiments, the sweetener may be a combination of one or more sugars and other natural and artificial sweeteners. In some embodiments, the sweetener is a caloric sweetener, such as sucrose, fructose, xylitol, erythritol, or combinations thereof. In some embodiments, the comestible compositions are free (or, in some embodiments) substantially free of stevia-derived sweeteners, such as steviol glycosides, glucosylated steviol glycosides, or rebaudiosides. For example, in some embodiments, the comestible compositions are either free of stevia-derived sweeteners or comprise stevia-derived sweeteners in a concentration of no more than 1000 ppm, or no more than 500 ppm, or no more than 200 ppm, or no more than 100 ppm, or no more than 50 ppm, or no more than 20 ppm, or no more than 10 ppm, or no more than 5 ppm, or no more than 3 ppm, or no more than 1 ppm.

In some embodiments, the sweetener component (d) comprises rebaudioside A and glucosylated steviol glycosides. The rebaudioside A can be present at any concentration such as those indicated above. The glucosylated steviol glycosides can be present at concentrations ranging from 1 ppm to 50 ppm, or from 1 ppm to 40 ppm, or from 1 ppm to 30 ppm, or from 1 ppm to 20 ppm, or from 1 ppm to 10 ppm. In some other embodiments, the rebaudioside A can be partially replaced by other steviol glycoside sweeteners, such as rebaudioside M.

The comestible compositions can, in certain embodiments, comprise any additional ingredients or combination of ingredients as are commonly used in food and beverage products, including, but not limited to:
acids, including, for example citric acid, phosphoric acid, ascorbic acid, sodium acid sulfate, lactic acid, or tartaric acid;
bitter ingredients, including, for example caffeine, quinine, green tea, catechins, polyphenols, green robusta coffee extract, green coffee extract, potassium chloride, menthol, or proteins (such as proteins and protein isolates derived from plants, algae, or fungi);
coloring agents, including, for example caramel color, Red #40, Yellow #5, Yellow #6, Blue #1, Red #3, purple carrot, black carrot juice, purple sweet potato, vegetable juice, fruit juice, beta carotene, turmeric curcumin, or titanium dioxide;
preservatives, including, for example sodium benzoate, potassium benzoate, potassium sorbate, sodium metabisulfate, sorbic acid, or benzoic acid;
antioxidants including, for example ascorbic acid, calcium disodium EDTA, alpha tocopherols, mixed tocopherols, rosemary extract, grape seed extract, resveratrol, or sodium hexametaphosphate;
vitamins or functional ingredients including, for example resveratrol, Co-Q10, omega 3 fatty acids, theanine, choline chloride (citocoline), fibersol, inulin (chicory root), taurine, Panax ginseng extract, guanana extract, ginger extract, L-phenylalanine, L-carnitine, L-tartrate, D-glucoronolactone, inositol, bioflavonoids, Echinacea, ginko biloba, yerba mate, flax seed oil, Garcinia cambogia rind extract, white tea extract, ribose, milk thistle extract, grape seed extract, pyrodixine HCl (vitamin B6), cyanoobalamin (vitamin B12), niacinamide (vitamin B3), biotin, calcium lactate, calcium pantothenate (pantothenic acid), calcium phosphate, calcium carbonate, chromium chloride, chromium polynicotinate, cupric sulfate, folic acid, ferric pyrophosphate, iron, magnesium lactate, magnesium carbonate, magnesium sulfate, monopotassium phosphate, monosodium phosphate, phosphorus, potassium iodide, potassium phosphate, riboflavin, sodium sulfate, sodium gluconate, sodium polyphosphate, sodium bicarbonate, thiamine mononitrate, vitamin D3, vitamin A palmitate, zinc gluconate, zinc lactate, or zinc sulphate;
clouding agents, including, for example ester gun, brominated vegetable oil (BVO), or sucrose acetate isobutyrate (SAIB);
buffers, including, for example sodium citrate, potassium citrate, or salt;
flavors, including, for example propylene glycol, ethyl alcohol, glycerine, gum Arabic (gum acacia), maltodextrin, modified corn starch, dextrose, natural flavor, natural flavor with other natural flavors (natural flavor WONF), natural and artificial flavors, artificial flavor, silicon dioxide, magnesium carbonate, or tricalcium phosphate; or
starches and stabilizers, including, for example pectin, xanthan gum, carboxylmethylcellulose (CMC), polysorbate 60, polysorbate 80, medium chain triglycerides, cellulose gel, cellulose gum, sodium caseinate, modified food starch, gum Arabic (gum acacia), inulin, or carrageenan.

The comestible compositions can have any suitable pH. In some embodiments, the mogroside compounds enhance the sweetness of a sweetener under a broad range of pH, e.g., from lower pH to neutral pH. The lower and neutral pH includes, but is not limited to, a pH from 1.5 to 9.0, or from 2.5 to 8.5; from 3.0 to 8.0; from 3.5 to 7.5; and from 4.0 to 7.

The comestible compositions set forth according to any of the foregoing embodiments, also include, in certain embodiments, one or more additional flavor-modifying compounds, such as compounds that enhance sweetness (e.g., hesperetin, naringenin, glucosylated steviol glycosides, etc.), compounds that block bitterness, compounds that enhance umami, compounds that reduce sourness or licorice taste, compounds that enhance saltiness, compounds that enhance a cooling effect, or any combinations of the foregoing.

Thus, in some embodiments, comestible compositions disclosed herein comprise one or more other sweetness enhancing compounds. Such sweetness enhancing compounds include, but are not limited to, naturally derived compounds, such as hesperitin, naringenin, glucosylated steviol glycosides, or synthetic compounds, such as any compounds set forth in U.S. Pat. Nos. 8,541,421; 8,815,956; 9,834,544; 8,592,592; 8,877,922; 9,000,054; and 9,000,051, as well as U.S. Patent Application Publication No. 2017/0119032. As used herein, the term “glucosylated steviol glycoside” refers to the product of enzymatically glucosylating natural steviol glycoside compounds. The glucosylation generally occurs through a glycosidic bond, such as an α-1,2 bond, an α-1,4 bond, an α-1.6 bond, a β-1,2 bond, a β-1,4 bond, a β-1,6 bond, and so forth. In some embodiments of any of the preceding embodiments, the comestible composition comprises 3-((4-amino-2,2-dioxo-1H-benzo[c][1,2,6]thiadiazin-5-yl)oxy)-2,2-dimethyl-N-propyl-propanamide.

In some further embodiments, comestible compositions disclosed herein comprise one or more umami enhancing compounds. Such umami enhancing compounds include, but are not limited to, naturally derived compounds, such as ericamide, or synthetic compounds, such as any compounds set forth in U.S. Pat. Nos. 8,735,081; 8,124,121; and 8,968,708.

In some further embodiments, comestible compositions disclosed herein comprise one or more cooling enhancing compounds. Such cooling enhancing compounds include, but are not limited to, naturally derived compounds, such as menthol or analogs thereof, or synthetic compounds, such as any compounds set forth in U.S. Pat. Nos. 9,394,287 and 10,421,727.

In some further embodiments, comestible compositions disclosed herein comprise one or more bitterness blocking compounds. Such bitterness blocking compounds include, but are not limited to, naturally derived compounds, such as menthol or analogs thereof, or synthetic compounds, such as any compounds set forth in U.S. Pat. Nos. 8,076,491; 8,445,692; and 9,247,759.

In some further embodiments, comestible compositions disclosed herein comprise one or more sour taste modulating compounds.

In some further embodiments, comestible compositions disclosed herein comprise one or more mouthfeel modifying compounds. Such mouthfeel modifying compounds include, but are not limited to, tannins, cellulosic materials, bamboo powder, and the like.

In some further embodiments, comestible compositions disclosed herein comprise one or more flavor masking compounds. Such flavor masking compounds include, but are not limited to, cellulosic materials, materials extracted from fungus, materials extracted from plants, citric acid, carbonic acid (or carbonates), and the like.

### Uses and Methods

The preceding comestible compositions can be out to use in any suitable ways to make various products, such as food products, beverage products, oral care products, animal feed products, and the like.

In at least one aspect, the disclosure provides uses of any comestible compositions of the first aspect.

In at least one aspect, the disclosure provides uses of any comestible compositions of the first aspect to increase the fiber content (for example, the prebiotic fiber content) of a flavored product. In some embodiments, such uses comprise providing support for making specific nutritional claims (for example, a nutrition claim that a flavored product is a “good source” of fiber or a “high source” of fiber, or a the prebiotic claim). In some embodiments, the flavored product is a food product, a beverage product, an oral care product, or an animal feed product (such as a dog feed or cat feed product).

In at least one aspect, the disclosure provides uses of any comestible compositions of the first aspect to enhance the texture of a flavored product. In some embodiments, the flavored product is a food product, a beverage product, an oral care product, or an animal feed product (such as a dog feed or cat feed product).

In at least one aspect, the disclosure provides uses of any comestible compositions of the first aspect to enhance the mouthfeel of a flavored product. In some embodiments, the flavored product is a food product, a beverage product, an oral care product, or an animal feed product (such as a dog feed or cat feed product).

In at least one aspect, the disclosure provides methods of increasing the fiber content (for example, the prebiotic fiber content) of a flavored product, the method comprising introducing an amount of any comestible compositions of the first aspect to the flavored product. In some embodiments, such methods comprise providing support for making specific nutritional claims (for example, a nutrition claim that a flavored product is a “good source” of fiber or a “high source” of fiber, or a the prebiotic claim). In some embodiments, the flavored product is a food product, a beverage product, an oral care product, or an animal feed product (such as a dog feed or cat feed product).

In at least one aspect, the disclosure provides methods of enhancing the texture of a flavored product, the method comprising introducing an amount of any comestible compositions of the first aspect to the flavored product. In some embodiments, the flavored product is a food product, a beverage product, an oral care product, or an animal feed product (such as a dog feed or cat feed product).

In at least one aspect, the disclosure provides methods of enhancing the mouthfeel of a flavored product, the method comprising introducing an amount of any comestible compositions of the first aspect to the flavored product. In some embodiments, the flavored product is a food product, a beverage product, an oral care product, or an animal feed product (such as a dog feed or cat feed product).

### Flavored Products

In certain aspects, the disclosure provides flavored products comprising any comestible compositions set forth above. In some embodiment, the flavored products are beverage products, such as soda, flavored water, tea, dairy analogues, and the like. In some other embodiments, the flavored products are food products, such as yogurt.

In embodiments where the flavored product is a beverage, the beverage may be selected from the group consisting of enhanced sparkling beverages, colas, lemon-lime flavored sparkling beverages, orange flavored sparkling beverages, grape flavored sparkling beverages, strawberry flavored sparkling beverages, pineapple flavored sparkling beverages, ginger-ales, root beers, fruit juices, fruit-flavored juices, juice drinks, nectars, vegetable juices, vegetable-flavored juices, sports drinks, energy drinks, enhanced water drinks, enhanced water with vitamins, near water drinks, coconut waters, tea type drinks, coffees, cocoa drinks, beverages containing milk components, beverages containing cereal extracts and smoothies. In some embodiments, the beverage may be a soft drink.

In certain embodiments of any aspects and embodiments set forth herein that refer to an flavored product, the flavored product is a non-naturally-occurring product, such as a packaged food or beverage product.

Further non-limiting examples of food and beverage products or formulations include sweet coatings, frostings, or glazes for such products or any entity included in the Soup category, the Dried Processed Food category, the Beverage category, the Ready Meal category, the Canned or Preserved Food category, the Frozen Processed Food category, the Chilled Processed Food category, the Snack Food category, the Baked Goods category, the Confectionery category, the Dairy Product category, the Ice Cream category, the Meal Replacement category, the Pasta and Noodle category, and the Sauces, Dressings, Condiments category, the Baby Food category, and/or the Spreads category.

In general, the Soup category refers to canned/preserved, dehydrated, instant, chilled, UHT and frozen soup. For the purpose of this definition soup(s) means a food prepared from meat, poultry, fish, vegetables, grains, fruit and other ingredients, cooked in a liquid which may include visible pieces of some or all of these ingredients. It may be clear (as a broth) or thick (as a chowder), smooth, pureed or chunky, ready-to-serve, semi-condensed or condensed and may be served hot or cold, as a first course or as the main course of a meal or as a between meal snack (sipped like a beverage). Soup may be used as an ingredient for preparing other meal components and may range from broths (consommé) to sauces (cream or cheese-based soups).

The Dehydrated and Culinary Food Category usually means: (i) Cooking aid products such as: powders, granules, pastes, concentrated liquid products, including concentrated bouillon, bouillon and bouillon like products in pressed cubes, tablets or powder or granulated form, which are sold separately as a finished product or as an ingredient within a product, sauces and recipe mixes (regardless of technology); (ii) Meal solutions products such as: dehydrated and freeze dried soups, including dehydrated soup mixes, dehydrated instant soups, dehydrated ready-to-cook soups, dehydrated or ambient preparations of ready-made dishes, meals and single serve entrees including pasta, potato and rice dishes; and (iii) Meal embellishment products such as: condiments, marinades, salad dressings, salad toppings, dips, breading, batter mixes, shelf stable spreads, barbecue sauces, liquid recipe mixes, concentrates, sauces or sauce mixes, including recipe mixes for salad, sold as a finished product or as an ingredient within a product, whether dehydrated, liquid or frozen.

The Beverage category usually means beverages, beverage mixes and concentrates, including but not limited to, carbonated and non-carbonated beverages, alcoholic and non-alcoholic beverages, ready to drink beverages, liquid concentrate formulations for preparing beverages such as sodas, and dry powdered beverage precursor mixes. The Beverage category also includes the alcoholic drinks, the soft drinks, sports drinks, isotonic beverages, and hot drinks. The alcoholic drinks include, but are not limited to beer, cider/perry, FABs, wine, and spirits. The soft drinks include, but are not limited to carbonates, such as colas and non-cola carbonates; fruit juice, such as juice, nectars, juice drinks and fruit flavored drinks; bottled water, which includes sparkling water, spring water and purified/table water, functional drinks, which can be carbonated or still and include sport, energy or elixir drinks; concentrates, such as liquid and powder concentrates in ready to drink measure. The drinks, either hot or cold, include, but are not limited to coffee or ice coffee, such as fresh, instant, and combined coffee; tea or ice tea, such as black, green, white, oolong, and flavored tea; and other drinks including flavor-, malt- or plant-based powders, granules, blocks or tablets mixed with milk or water.

The Snack Food category generally refers to any food that can be a light informal meal including, but not limited to Sweet and savory snacks and snack bars. Examples of snack food include, but are not limited to fruit snacks, chips/crisps, extruded snacks, tortilla/corn chips, popcorn, pretzels, nuts and other sweet and savory snacks. Examples of snack bars include, but are not limited to granola/muesli bars, breakfast bars, energy bars, fruit bars and other snack bars.

The Baked Goods category generally refers to any edible product the process of preparing which involves exposure to heat or excessive sunlight. Examples of baked goods include, but are not limited to bread, buns, cookies, muffins, cereal, toaster pastries, pastries, waffles, tortillas, biscuits, pies, bagels, tarts, quiches, cake, any baked foods, and any combination thereof.

The Ice Cream category generally refers to frozen dessert containing cream and sugar and flavoring. Examples of ice cream include, but are not limited to: impulse ice cream; take-home ice cream; frozen yoghurt and artisanal ice cream; soy, oat, bean (e.g., red bean and mung bean), and rice-based ice creams.

The Confectionery category generally refers to edible product that is sweet to the taste. Examples of confectionery include, but are not limited to candies, gelatins, chocolate confectionery, sugar confectionery, gum, and the likes and any combination products.

The Meal Replacement category generally refers to any food intended to replace the normal meals, particularly for people having health or fitness concerns. Examples of meal replacement include, but are not limited to slimming products and convalescence products.

The Ready Meal category generally refers to any food that can be served as meal without extensive preparation or processing. The ready meal includes products that have had recipe “skills” added to them by the manufacturer, resulting in a high degree of readiness, completion and convenience. Examples of ready meal include, but are not limited to canned/preserved, frozen, dried, chilled ready meals; dinner mixes; frozen pizza; chilled pizza; and prepared salads.

The Pasta and Noodle category includes any pastas and/or noodles including, but not limited to canned, dried and chilled/fresh pasta; and plain, instant, chilled, frozen and snack noodles.

The Canned/Preserved Food category includes, but is not limited to canned/preserved meat and meat products, fish/seafood, vegetables, tomatoes, beans, fruit, ready meals, soup, pasta, and other canned/preserved foods.

The Frozen Processed Food category includes, but is not limited to frozen processed red meat, processed poultry, processed fish/seafood, processed vegetables, meat substitutes, processed potatoes, bakery products, desserts, ready meals, pizza, soup, noodles, and other frozen food.

The Dried Processed Food category includes, but is not limited to rice, dessert mixes, dried ready meals, dehydrated soup, instant soup, dried pasta, plain noodles, and instant noodles. The Chill Processed Food category includes, but is not limited to chilled processed meats, processed fish/seafood products, lunch kits, fresh cut fruits, ready meals, pizza, prepared salads, soup, fresh pasta and noodles.

The Sauces, Dressings and Condiments category includes, but is not limited to tomato pastes and purees, bouillon/stock cubes, herbs and spices, monosodium glutamate (MSG), table sauces, soy based sauces, pasta sauces, wet/cooking sauces, dry sauces/powder mixes, ketchup, mayonnaise, mustard, salad dressings, vinaigrettes, dips, pickled products, and other sauces, dressings and condiments.

The Baby Food category includes, but is not limited to milk- or soybean-based formula; and prepared, dried and other baby food.

The Spreads category includes, but is not limited to jams and preserves, honey, chocolate spreads, nut based spreads, and yeast based spreads.

The Dairy Product category generally refers to edible product produced from mammal's milk. Examples of dairy product include, but are not limited to drinking milk products, cheese, yoghurt and sour milk drinks, and other dairy products.

Additional examples for flavored products, particularly food and beverage products or formulations, are provided as follows. Exemplary comestible compositions include one or more confectioneries, chocolate confectionery, tablets, countlines, bagged selflines/softlines, boxed assortments, standard boxed assortments, twist wrapped miniatures, seasonal chocolate, chocolate with toys, alfajores, other chocolate confectionery, mints, standard mints, power mints, boiled sweets, pastilles, gums, jellies and chews, toffees, caramels and nougat, medicated confectionery, lollipops, liquorice, other sugar confectionery, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savory biscuits and crackers, bread substitutes, breakfast cereals, rte cereals, family breakfast cereals, flakes, muesli, other cereals, children's breakfast cereals, hot cereals, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavored, functional and other condensed milk, flavored milk drinks, dairy only flavored milk drinks, flavored milk drinks with fruit juice, soy milk, sour milk drinks, fermented dairy drinks, coffee whiteners, powder milk, flavored powder milk drinks, cream, cheese, processed cheese, spreadable processed cheese, unspreadable processed cheese, unprocessed cheese, spreadable unprocessed cheese, hard cheese, packaged hard cheese, unpackaged hard cheese, yoghurt, plain/natural yoghurt, flavored yoghurt, fruited yoghurt, probiotic yoghurt, drinking yoghurt, regular drinking yoghurt, probiotic drinking yoghurt, chilled and shelf-stable desserts, dairy-based desserts, soy-based desserts, chilled snacks, fromage frais and quark, plain fromage frais and quark, flavored fromage frais and quark, savory fromage frais and quark, sweet and savory snacks, fruit snacks, chips/crisps, extruded snacks, tortilla/corn chips, popcorn, pretzels, nuts, other sweet and savory snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, frozen pizza, chilled pizza, soup, canned soup, dehydrated soup, instant soup, chilled soup, hot soup, frozen soup, pasta, canned pasta, dried pasta, chilled/fresh pasta, noodles, plain noodles, instant noodles, cups/bowl instant noodles, pouch instant noodles, chilled noodles, snack noodles, canned food, canned meat and meat products, canned fish/seafood, canned vegetables, canned tomatoes, canned beans, canned fruit, canned ready meals, canned soup, canned pasta, other canned foods, frozen food, frozen processed red meat, frozen processed poultry, frozen processed fish/seafood, frozen processed vegetables, frozen meat substitutes, frozen potatoes, oven baked potato chips, other oven baked potato products, non-oven frozen potatoes, frozen bakery products, frozen desserts, frozen ready meals, frozen pizza, frozen soup, frozen noodles, other frozen food, dried food, dessert mixes, dried ready meals, dehydrated soup, instant soup, dried pasta, plain noodles, instant noodles, cups/bowl instant noodles, pouch instant noodles, chilled food, chilled processed meats, chilled fish/seafood products, chilled processed fish, chilled coated fish, chilled smoked fish, chilled lunch kit, chilled ready meals, chilled pizza, chilled soup, chilled/fresh pasta, chilled noodles, oils and fats, olive oil, vegetable and seed oil, cooking fats, butter, margarine, spreadable oils and fats, functional spreadable oils and fats, sauces, dressings and condiments, tomato pastes and purees, bouillon/stock cubes, stock cubes, gravy granules, liquid stocks and fonds, herbs and spices, fermented sauces, soy based sauces, pasta sauces, wet sauces, dry sauces/powder mixes, ketchup, mayonnaise, regular mayonnaise, mustard, salad dressings, regular salad dressings, low fat salad dressings, vinaigrettes, dips, pickled products, other sauces, dressings and condiments, baby food, milk formula, standard milk formula, follow-on milk formula, toddler milk formula, hypoallergenic milk formula, prepared baby food, dried baby food, other baby food, spreads, jams and preserves, honey, chocolate spreads, nut-based spreads, and yeast-based spreads. Exemplary comestible compositions also include confectioneries, bakery products, ice creams, dairy products, sweet and savory snacks, snack bars, meal replacement products, ready meals, soups, pastas, noodles, canned foods, frozen foods, dried foods, chilled foods, oils and fats, baby foods, or spreads or a mixture thereof. Exemplary comestible compositions also include breakfast cereals, sweet beverages or solid or liquid concentrate compositions for preparing beverages, ideally so as to enable the reduction in concentration of previously known saccharide sweeteners, or artificial sweeteners.

Some embodiments provide a chewable composition that may or may not be intended to be swallowed. In some embodiments, the chewable composition may be gum, chewing gum, sugarized gum, sugar-free gum, functional gum, bubble gum including compounds as disclosed and described herein, individually or in combination.

In some embodiments, the flavored product further comprises: a carrier, and, optionally, at least one adjuvant. The term “carrier” denotes a usually inactive accessory substance, such as solvents, binders, bulking agents, or other inert medium, which is used in combination with the present compound and one or more optional adjuvants to form the formulation. For example, water or starch can be a carrier for a flavored product. In some embodiments, the carrier is the same as the diluting medium for reconstituting the flavored product; and in other embodiments, the carrier is different from the diluting medium. The term “carrier” as used herein includes, but is not limited to, comestibly acceptable carrier.

The term “adjuvant” denotes an additive which supplements, stabilizes, maintains, or enhances the intended function or effectiveness of the active ingredient, such as the compound of the present invention. In one embodiment, the at least one adjuvant comprises one or more flavoring agents. The flavoring agent may be of any flavor known to one skilled in the art or consumers, such as the flavor of chocolate, coffee, tea, mocha, French vanilla, peanut butter, chai, or combinations thereof. In another embodiment, the at least one adjuvant comprises one or more sweeteners. The one or more sweeteners can be any of the sweeteners described in this application. In another embodiment, the at least one adjuvant comprises one or more ingredients selected from the group consisting of a emulsifier, a stabilizer, an antimicrobial preservative, an antioxidant, vitamins, minerals, fats, starches, protein concentrates and isolates, salts, and combinations thereof. Examples of emulsifiers, stabilizers, antimicrobial preservatives, antioxidants, vitamins, minerals, fats, starches, protein concentrates and isolates, and salts are described in U.S. Pat. No. 6,468,576, the content of which is hereby incorporated by reference in its entirety for all purposes.

The flavored product may further comprise a freezing point depressant, nucleating agent, or both as the at least one adjuvant. The freezing point depressant is an ingestibly acceptable compound or agent which can depress the freezing point of a liquid or solvent to which the compound or agent is added. That is, a liquid or solution containing the freezing point depressant has a lower freezing point than the liquid or solvent without the freezing point depressant. In addition to depress the onset freezing point, the freezing point depressant may also lower the water activity of the flavored product. The examples of the freezing point depressant include, but are not limited to, carbohydrates, oils, ethyl alcohol, polyol, e.g., glycerol, and combinations thereof. The nucleating agent denotes an ingestibly acceptable compound or agent which is able to facilitate nucleation. The presence of nucleating agent in the flavored product can improve the mouthfeel of the frozen Blushes of a frozen slush and to help maintain the physical properties and performance of the slush at freezing temperatures by increasing the number of desirable ice crystallization centers. Examples of nucleating agents include, but are not limited to, calcium silicate, calcium carbonate, titanium dioxide, and combinations thereof.

In some embodiments, the flavored product is formulated to have a low water activity for extended shelf life (for example, nutritional snacks, protein bars, cookies, and the like). Water activity is the ratio of the vapor pressure of water in a formulation to the vapor pressure of pure water at the same temperature. In one embodiment, the flavored product has a water activity of less than about 0.60. In another embodiment, the flavored product has a water activity of less than about 0.55. In another embodiment, the flavored product has a water activity of less than about 0.50.

In some embodiments, the flavored product is a beverage product, such as a beverage product comprising a plant extract or concentrate, such as an extract or concentrate from oats, soy, almond, cashew, rice, coconut, hemp, and the like. The comestible composition can be incorporated into or introduced to the flavored product in any suitable concentration. For example, in some embodiments, the flavored product comprises from 0.1 percent by weight to 20 percent by weight, or from 1 percent by weight to 15 percent by weight, or from 3 percent by weight to 10 percent by weight, of the plant extract or concentrate, based on the total weight of the beverage product (including water).

### Non-Animal Protein Materials and Products Made Therefrom

In certain aspects, the disclosure provides a flavored product comprising a plant-based material (such as a plant-based starch, a plant-based protein, or a combination thereof) and the comestible compositions disclosed herein. In some embodiments, the flavored product is a beverage, such as soy milk, almond milk, rice milk, oat milk, a protein drink, a meal-replacement drink, or other like product. In some other embodiments, the flavored product is a meat-replacement product, such as a plant-based chicken product (such as a plant-based chicken nugget), a plant-based beef product (such as a plant-based burger), and the like. In some other embodiments, the flavored product is a protein powder, a meal-replacement powder, a plant-based creamer for coffee or tea, and the like. In certain further embodiments, any such products contain additional ingredients, and have additional features, as are typically used in the preparation and/or manufacture of such products. For example, the comestible compositions disclosed herein, may be combined with other flavors and taste modifiers, and may even be encapsulated in certain materials, according to known technologies in the relevant art. Suitable concentrations of the comestible compositions disclosed herein, or comestibly acceptable salts thereof, are set forth above.

In some further embodiments analogous to the above embodiments, proteins or starches from algal or fungal sources can be used instead of or in combination with plant starches or proteins.

### Non-Meat Protein Materials and Products Made Therefrom

Certain non-meat animal proteins, such as dairy proteins and proteins from bone broth, are commonly used in food products, and are also sold as the primary ingredient in certain protein powders. Such proteins can impart flavors that lack the full umami or kokumi taste that consumers may desire. This is especially true for protein isolates, such as protein isolates of whey protein, collagen protein, casein proteins, and the like. Thus, the present disclosure provides comestible compositions that include non-meat animal proteins. The TM1 compound, or its comestibly acceptable salts, can be present in any suitable combination, according to the embodiments set forth in the preceding sections of the present disclosure. In some embodiments, the non-meat animal protein is a bone protein, such as a collagen protein derived from the bones of an animal, such as a cow, pig, donkey, horse, chicken, duck, goat, goose, rabbit, lamb, sheep, buffalo, ostrich, camel, and the like. In some embodiments, the non-meat animal protein is a milk protein, such as a whey protein, a casein protein, or any combination thereof. The milk can be the milk of any suitable animal, such as a cow, donkey, horse, sheep, buffalo, camel, and the like.

The comestible compositions disclosed herein can also be included in certain food or beverage products that include animal milk or materials derived from animal milk. Such products include cheeses, cheese spreads, yogurt, kefir, milk, processed dairy products, cottage cheese, sour cream, butter, and the like.

### Methods of Preparation

The comestible compositions disclosed herein can be made by any suitable means, as typically employed in the manufacturing of fiber blends. Such methods include dry mixing, granulating, encapsulating, spray drying, and the like.

### EXAMPLES

To further illustrate this invention, the following examples are included. The examples should not, of course, be construed as specifically limiting the invention. Variations of these examples within the scope of the claims are within the purview of one skilled in the art and are considered to fall within the scope of the invention as described, and claimed herein. The reader will recognize that the skilled artisan, armed with the present disclosure, and skill in the art is able to prepare and use the invention without exhaustive examples.

### Example 1—Fiber Blends

Table 1 below shows a series of different fiber blends, where the numbers reported indicate the relative weight percent of that fiber in the fiber blend. In each case, comestible compositions containing such fibers can also include protein components and/or sweetening components and/or other components, as described above. The far left column indicates the type of fiber: INL=inulin; DRD=digestion-resistant dextrin (for example, soluble corn fiber); PSY=psyllium fiber; and PEA=pea fiber.

TABLE 1

| | A | B | C | D | E | F | G |
|---|---|---|---|---|---|---|---|
| INL | 90.3 | 71.4 | 88.2 | 66.7 | 88.2 | 66.7 | — |
| DRD | 4.8 | 14.2 | 3.9 | 11.0 | 7.8 | 22.1 | 97.1 |
| PSY | 2.0 | 5.7 | 3.2 | 8.9 | 1.6 | 4.4 | 1.2 |
| PEA | 2.9 | 8.7 | 4.7 | 13.4 | 2.4 | 6.8 | 1.8 |

TABLE 2

| | H | I | J | K | L | M | N |
|---|---|---|---|---|---|---|---|
| INL | — | 80.4 | 16.3 | 82.9 | 78.9 | 78.9 | — |
| DRD | 94.3 | 19.6 | 83.7 | 8.5 | 7.0 | 14.0 | 92.3 |
| PSY | 2.3 | — | — | 3.4 | 5.6 | 2.8 | 3.1 |
| PEA | 3.4 | — | — | 5.2 | 8.5 | 4.3 | 4.6 |

TABLE 3

| | O | P | Q | R | S | T | U |
|---|---|---|---|---|---|---|---|
| INL | — | 83.3 | — | — | — | — | 47.5 |
| DRD | 96.0 | — | 49.8 | 65.7 | 33.8 | — | 52.5 |
| PSY | 1.6 | 6.7 | 20.0 | 13.6 | 26.4 | 40.0 | — |
| PEA | 2.4 | 10.0 | 30.2 | 20.7 | 39.8 | 60.0 | — |

TABLE 4

| | V | W | X | Y | Z |
|---|---|---|---|---|---|
| INL | 94.3 | 90.0 | — | — | 83.3 |
| DRD | — | — | — | — | — |
| PSY | 2.3 | 10.0 | 2.3 | 40.0 | 6.7 |
| PEA | 2.4 | — | 2.4 | 20.0 | 10.0 |
| Acacia | — | — | 94.3 | 40.0 | — |

### Example 2—Oat Milk

The fiber blend identified as Blend N in Table 2 was used to make a fiber-enhanced oat milk beverage. Table 5 below sets forth their ingredients and relative amounts by weight.

TABLE 5

| | |
|---|---|
| Oat Base Concentrate | 10.0 |
| Sunflower Oil | 1.50 |
| Potassium Phosphate | 0.20 |
| Calcium Carbonate | 0.15 |
| Sodium Chloride | 0.12 |
| Gum Arabic | 0.40 |
| Fiber Blend N (Table 2) | 7.66 |
| Water | 80.0 |

The dry ingredients are mixed together, with at least 10 minutes of mixing under high shear conditions. The liquid ingredients were then blended into the dry ingredients, and the resulting mixture was homogenized in two stages at 500 psi and then at 2000 psi. The homogenized mixture was treated at 150° C. for 3 seconds, and was allowed to cool to 30° C. The mixture was used to fill cartons at that temperature, and was refrigerated immediately. The mixture was subjected to sensory testing against a control beverage that lacks the fiber ingredient (and makes up the difference in water). A small equivalent amount of caramel flavoring was added to both. Sensory panelists were asked to evaluate the two samples on the following criteria: sweetness, bitterness, cereal taste, creaminess, milkiness, caramel taste, astringency, mouthfeel, fattiness, and thickness. A panel of 27 sensory panelists tasted the control and the test sample and rated the two samples from 1 to 10 on each of these attributes, with 10 signifying greater intensity of the criterion in question. Table 6 sets forth the results.

TABLE 6

| | Control | Test Sample |
|---|---|---|
| Sweetness | 3.8 | 6.0 |
| Bitterness | 2.3 | 1.8 |
| Cereal Taste | 4.4 | 4.5 |
| Creaminess | 4.0 | 5.3 |
| Milkiness | 4.2 | 4.8 |
| Caramel Taste | 3.8 | 4.7 |
| Astringency | 1.4 | 1.3 |
| Mouthfeel | 3.2 | 4.7 |
| Fattiness | 2.9 | 4.0 |
| Thickness | 3.3 | 4.6 |

The test sample was evaluated as better on eight (8) of the ten (10) criteria, and as similar on two (2) of the ten (10) criteria. The test sample was not worse than the control on any of the criteria. Thus, the results demonstrate that adding fiber-containing compositions, such as those described herein, can be used to enhance sweetness, mast bitterness, enhance creaminess, enhance milkiness, enhance flavor (caramel flavor, in this case), enhance mouthfeel, enhance perceived fattiness, and enhance thickness of a beverage article.

### Example 3—Fiber-Enriched Chocolate Beverage

Commercial chocolate milk was enhanced with (3A) resistant dextran (5 g per 240 mL serving) and (3B) resistant dextran (5 g per 240 mL serving) plus psyllium and pea fiber (Blend N from Table 2). Similar sensory tests were performed as in Example 2, this time testing for sweetness, bitterness, chocolate flavor, creaminess, astringency, mouthfeel, fattiness, and thickness. In this instance, the scale was from 1 to 5, with 5 corresponding to highest intensity for the attribute. Table 7 sets forth the results.

TABLE 7

| | Control | Test Sample 3A | Test Sample 3B |
|---|---|---|---|
| Sweetness | 1.3 | 1.5 | 1.4 |
| Bitterness | 3.7 | 2.7 | 2.9 |
| Creaminess | 3.0 | 3.4 | 3.9 |
| Chocolate Taste | 2.5 | 2.3 | 2.4 |
| Astringency | 3.5 | 3.4 | 3.0 |
| Mouthfeel | 4.1 | 3.7 | 4.0 |
| Fattiness | 3.2 | 3.4 | 3.7 |
| Thickness | 3.1 | 3.2 | 4.1 |

The data show that addition of the fiber blends show significant enhancement with respect to creaminess and thickness, and significant masking of bitterness. The addition of fiber did not compromise any other attributes in a significant way.

### Example 4—Fiber-Enriched Reduced-Sugar Cookie

A reduced-sugar cookie was prepared using standard ingredients. Table 8 shows the relative amounts (in weight) for ingredients in a control cookie and a test sample. The fiber blend used in the test sample us Blend K from Table 2 above.

TABLE 8

| | Control | Test Sample |
|---|---|---|
| Vegetable Shortening | 10.0 | 10.0 |
| Unsalted Butter | 15.0 | 15.0 |
| Sugar (Sucrose) | 26.0 | 21.0 |
| Baking Powder | 0.80 | 0.80 |
| Sodium Chloride | 0.50 | 0.50 |
| Vanilla Flavoring | 0.03 | 0.03 |
| Fiber Blend K | — | 5.0 |
| Steviosides* | — | 0.01 |

*blend of glucosylated steviol glycosides (PureCircle) and rebaudioside A

The above ingredients were mixed together according to a standard recipe for making a sugar cookie. Sensory panelists were asked to evaluate the two samples on the following criteria: sweetness, overall flavor, vanilla flavor, butter flavor, saltiness, firmness, grittiness, and crispiness. A panel of 27 sensory panelists tasted the control and the test sample and rated the two samples from 1 to 10 on each of these attributes, with 10 signifying greater intensity of the criterion in question. Table 9 sets forth the results.

TABLE 9

| | Control | Test Sample |
|---|---|---|
| Sweetness | 6.3 | 6.0 |
| Overall Flavor | 6.0 | 5.9 |
| Vanilla Flavor | 5.3 | 5.3 |
| Butter Flavor | 5.2 | 5.2 |
| Saltiness | 3.7 | 3.7 |
| Firmness | 4.6 | 4.6 |
| Grittiness | 3.5 | 3.5 |
| Crispness | 4.2 | 4.0 |

As shown above, the test cookie with less sugar and increased fiber was evaluated as equivalent to the test cookie on all parameters. Thus, the fiber blends disclosed herein can increase the fiber content of such products without detracting from the desirable qualities.

### Example 5—Pea Protein Beverage

A pea protein beverage was prepared with a control having no added fiber, and four test samples using different amounts of fiber. Table 10 sets forth the compositions. Amounts are given in relative weight percent.

TABLE 10

| | Control | Test 5A | Test 5B | Text 5C | Test 5D |
|---|---|---|---|---|---|
| Pea Protein Isolate | 5.05 | 5.05 | 5.05 | 5.05 | 5.05 |
| Sugar (Sucrose) | 3.0 | 3.0 | 3.0 | 3.0 | 3.0 |
| Gellan Gum | 0.03 | 0.03 | 0.03 | 0.03 | 0.03 |
| Potassium Phosphate | 0.20 | 0.20 | 0.20 | 0.20 | 0.20 |
| C8-12 Triglycerides | 1.50 | 1.50 | 1.50 | 1.50 | 1.50 |
| Gum Arabic | 0.20 | 0.20 | 0.20 | 0.20 | 0.20 |
| Fiber Blend N (above) | — | 1.90 | 3.72 | 7.47 | — |
| Fiber Blend M (above) | — | — | — | — | 6.72 |
| Water | 90.0 | 88.1 | 86.3 | 82.6 | 83.3 |

The control and test samples were all subject to homogenization, and their viscosity using a Brookfield viscometer (60 rpm) was measured under refrigerated conditions immediately after homogenization, one (1) day later, and seven (7) days later. Table 11 sets forth the results.

TABLE 11

| | Day 0 (cP) | Day 1 (cP) | Day 7 (cP) |
|---|---|---|---|
| Control | 5.97 | 6.61 | 6.93 |
| Test Sample 5A | 7.25 | 9.49 | 10.77 |
| Test Sample 5B | 9.49 | 12.27 | 13.44 |
| Test Sample 5C | 23.57 | 34.35 | 39.57 |
| Test Sample 5D | 17.81 | 24.32 | 27.68 |

The results indicate that the beverage compositions formed using the fiber compositions disclosed herein form shelf-stable compositions over a range of fiber concentrations.

1. A beverage product comprising a comestible fiber composition, wherein the comestible fiber composition comprises: (a) from 75% to 97% by weight of inulin, a digestion-resistant dextrin, or a combination thereof, based on the total weight of fiber in the beverage product; and (b) from 2% to 8% by weight of a texturizing fiber component, based on the total weight of fiber in the beverage product, wherein the texturizing fiber component comprises pea fiber, psyllium fiber, or a combination thereof;
wherein the weight ratio of soluble fiber to insoluble fiber in the texturizing fiber component ranges from 1:3 to 3:1.

2. (canceled)

3. (canceled)

4. The beverage product of claim 1, further comprising a plant extract or concentrate, such as an extract or concentrate from oats, soybeans, almonds, cashews, rice, coconut, hemp, or any combination thereof.

5. The beverage product of claim 1, further comprising a protein component.

6. The beverage product of claim 5, wherein the protein component comprises a non-animal protein, such as a plant protein, an algal protein, or a mycoprotein.

7. The beverage product of claim 1, further comprising a sweetener component.

8. The beverage product of claim 7, wherein the sweetener component comprises a steviol glycoside, a mogroside, sucralose, aspartame, cyclamate, saccharin, acesulfame potassium, or any combination thereof.

9. The beverage product of claim 8, wherein the sweetener component comprises rebaudioside A, rebaudioside B, rebaudioside B, rebaudioside M, or any combination thereof.

10. The beverage product of claim 7, wherein the sweetener component further comprises a sweetness enhancer.

11. The beverage product of claim 1, which is a dairy analogue product.
